(19) United States
(12) Patent Application Publication
(10) Pub. No.: US 2008/0143519 A1
(43) Pub. Date: Jun. 19, 2008

(54) TAMPER-INDICATING RADIO FREQUENCY IDENTIFICATION TAG AND METHODS OF INDICATING TAMPERING OF A RADIO FREQUENCY IDENTIFICATION TAG

(75) Inventor: Chester Piotrowski, White Bear Lake, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/613,082

(22) Filed: Dec. 19, 2006

(51) Int. Cl. G08B 21/00

(52) U.S. Cl. 340/540

(57) ABSTRACT

A tamper-indicating radio frequency identification tag including a substrate comprising piezoelectric material. The present invention also relates to methods of indicating that a radio frequency identification tag has been tampered with.

### TECHNICAL FIELD

The present invention relates to a tamper-indicating radio frequency identification tag including a substrate comprising piezoelectric material. The present invention also relates to methods of indicating that a radio frequency identification tag has been tampered with.

### BACKGROUND OF THE INVENTION

Radio Frequency Identification (“RFID”) technology is becoming widely used in virtually every industry, including transportation, shipping, manufacturing, postal tracking, consumer goods, food, medical practice, airline baggage reconciliation, and highway toll management.

A typical RFID system includes a plurality of RFID tags or labels, at least one RFID reader or detection system having an antenna for communication with the RFID tags or labels, and a computing device to control the RFID reader. An RFID tag typically does not include a layer of adhesive. An RFID label typically is an RFID tag having a layer of adhesive for attaching the RFID tag to an item. RFID tags typically include an integrated circuit and an antenna, the combination of which are often commonly referred to in the industry as an “RFID inlay.” The RFID reader includes a transmitter that may provide energy or information to the tags or labels, and a receiver to receive identity and other information from the tags or labels. The computing device can process the information obtained by the RFID reader.

In general, the information received from an RFID tag or label is specific to the particular application, but often provides identification for an article to which the tag is affixed. Exemplary articles include manufactured items, shipping containers, books, files, industrial, medical or forensic samples, animals, or virtually any other tangible article. Additional information may also be provided for the article. The tag or label may be used during a manufacturing process, for example, to indicate a paint color of an automobile chassis during manufacturing or other useful information.

The transmitter of the RFID reader outputs RF signals through the antenna to create an electromagnetic field that enables the tags or labels to return an RF signal carrying the information. The transmitter makes use of an amplifier to drive the antenna with a modulated output signal.

A conventional RFID tag or label may be an “active” tag or label that includes an internal power source, or a “passive” tag or label that is energized by the field created by the RFID reader antenna. Once energized, the tags and labels communicate using a pre-defined protocol, allowing the RFID reader to receive information from one or more tags or labels. The computing device serves as an information management system by receiving the information from the RFID reader and performing some action, such as updating a database. In addition, the computing device may serve as a mechanism for programming data into the tags or label via the transmitter

A typical RFID system includes RFID tags or labels that are affixed to objects and an RFID reader that can read unique identification information stored on the tag or label and provides generally automated, typically error-free identification of the objects, and optionally may write information to the RFID tag or label.

An example of a radio frequency identification sticker is disclosed in U.S. Pat. No. 6,121,880 (Scott et al.), “Sticker Transponder for Use on Glass Surface.” This patent discloses a sticker transponder adapted to be affixed to a glass surface, such as a vehicle windshield, including a RFID transponder enabling the storage and retrieval of vehicle related data. The sticker transponder comprises a flexible circuit substrate having an antenna formed thereon and a transponder circuit disposed on the substrate and coupled to the antenna. An adhesive layer is coupled to a first surface of the flexible circuit substrate. An indicia layer is coupled to a second surface of the flexible circuit opposite from the first surface. The indicia layer comprises a space permitting indicia to be printed thereon. The antenna has a characteristic impedance defined in part by a dielectric constant of the glass surface. As a result, a proper impedance match between the antenna and the transponder circuit is achieved only when the sticker is affixed to the glass surface. The sticker transponder further comprises a release liner affixed to the adhesive layer, the release liner being selectively removable to permit the sticker transponder to be affixed to the glass surface. The transponder circuit further includes a memory having a read-only portion and a re-writable portion.

An example of a tamper indicating radio frequency identification label is disclosed in U.S. Pat. No. 6,888,509 (Atherton), “A Tamper Indicating Radio Frequency Identification Label.” This patent discloses a label, which may include RFID components and a tamper track coupled to the RFID components. The tamper track should be constructed from a destructible conducting path. Additionally, the tamper rack can be formed such that it is damaged when the label is tampered. In one embodiment, adhesion characteristics of the tamper track (102) are adapted to break apart the tamper track when the label is tampered, for example, by removal from an object. The RFID components may retain their RF capability and detect when the tamper track (102) has been damaged to indicate that the label has been tampered. Alternatively, the RFID capability of the RFID components may be disabled when the tamper track is damaged, indicating tampering.

Another example of a tamper indicating radio frequency identification sticker is disclosed in U.S. Pat. No. 7,102,522 (Kuhns), “A Tamper-Indicating Radio Frequency Antenna and Sticker, a Radio Frequency Antenna, and Methods of Using the Same. This patent discloses a tamper-indicating radio frequency identification device made of densified metal powder and to methods of indicating that a radio frequency identification antenna or sticker has been tampered with.

### SUMMARY OF THE INVENTION

One aspect of the present invention provides a tamper-indicating radio frequency identification tag. The radio frequency identification tag comprises: a substrate including a first major surface and a second major surface opposite the first major surface, where the substrate comprises piezoelectric material; a radio frequency identification antenna on the first major surface of the substrate; and an integrated circuit electrically connected to the first antenna; and where a voltage is generated in the piezoelectric material when the tag is tampered with.

Another aspect of the present invention provides an alternative tamper-indicating radio frequency identification tag. The tamper-indicating radio frequency identification tag comprises: a substrate including a first major surface and a second major surface opposite the first major surface, wherein the substrate comprises piezoelectric material; and a radio frequency identification antenna on the first major surface of the substrate; and an integrated circuit electrically connected to the first antenna, wherein the integrated circuit comprises a memory for recording events; where when tampering of the tag occurs, a voltage is generated in the piezoelectric material and an event is recorded in the memory.

Another aspect of the present invention provides a method of indicating that a radio frequency identification sticker has been tampered. The method comprises the steps of: providing a tamper-indicating radio frequency identification tag, comprising: a substrate including a first major surface and a second major surface opposite the first major surface, where the substrate comprises piezoelectric material; a radio frequency identification antenna on the first major surface of the substrate; and an integrated circuit electrically connected to the first antenna; where a voltage is generated in the piezoelectric material when the tag is tampered with; attaching the tamper-indicating radio frequency identification tag to an assigned item; tampering with radio frequency identification tag to attempt to remove or removing the tag from the assigned item; and receiving an indication that the radio frequency identification tag has been tampered with by detecting the voltage generated in the piezoelectric material.

### BRIEF DESCRIPTION OF THE DRAWINGS

The present invention will be further explained with reference to the appended Figures, wherein like structure is referred to by like numerals throughout the several views, and wherein:

FIG. 1 is a schematic cross sectional view of one embodiment of a tamper-indicating radio frequency identification tag of the present invention;

FIG. 2 is a schematic cross sectional view of another embodiment of a tamper-indicating radio frequency identification tag of the present invention;

FIG. 3 is a schematic cross sectional view of another embodiment of a tamper-indicating radio frequency identification tag of the present invention; and

FIG. 4 is a schematic cross sectional view of yet another embodiment of a tamper-indicating radio frequency identification tag of the present invention.

### DETAILED DESCRIPTION OF THE INVENTION

Electronic Vehicle Registration (“EVR”) is known in the art generally as an automated method of compliance screening for vehicle registration, which typically uses wireless, radio frequency identification (“RFID”) technology to automatically identify vehicle compliance status using RFID readers and RFID tags to reflect vehicle information. Typically, an RFID tag is attached to a vehicle, usually the windshield. A user may use an RFID scanner to interrogate the RFID tag associated with the vehicle to obtain a unique number stored on the RFID tag. This unique number may be the unique registration number assigned to the vehicle, the unique serial number assigned to the RFID tag during manufacture, or some other unique number stored on the RFID tag which can be associated with the vehicle. Using the unique number obtained from the RFID tag, a user accesses a database, typically stored at another location, to download compliance-related information about the vehicle to which the RFID tag is assigned. Examples of compliance-related information may include vehicle registration, emissions, insurance, mechanical safety, or other factors, and whether or not the vehicle is in compliance with various national, state, or local regulations. Some EVR systems automatically process enforcement actions or violations for non-compliant vehicles. EVR tags typically supplement the traditional vehicle license plate and provide an additional, automated method for enforcing registration compliance.

Some examples of EVR systems or related RFID-tags known in the art are as follows: U.S. Pat. No. 6,894,615, U.S. Pat. No. 6,758,405, U.S. Pat. No. 5,661,473, U.S. Pat. No. 5,554,984, U.S. Pat. No. 6,366,222, U.S. Pat. No. 6,876,296, U.S. Pat. No. 6,121,880, U.S. Pat. No. 6,888,509, and U.S. Pat. Application Publication No. 2002/0044069.

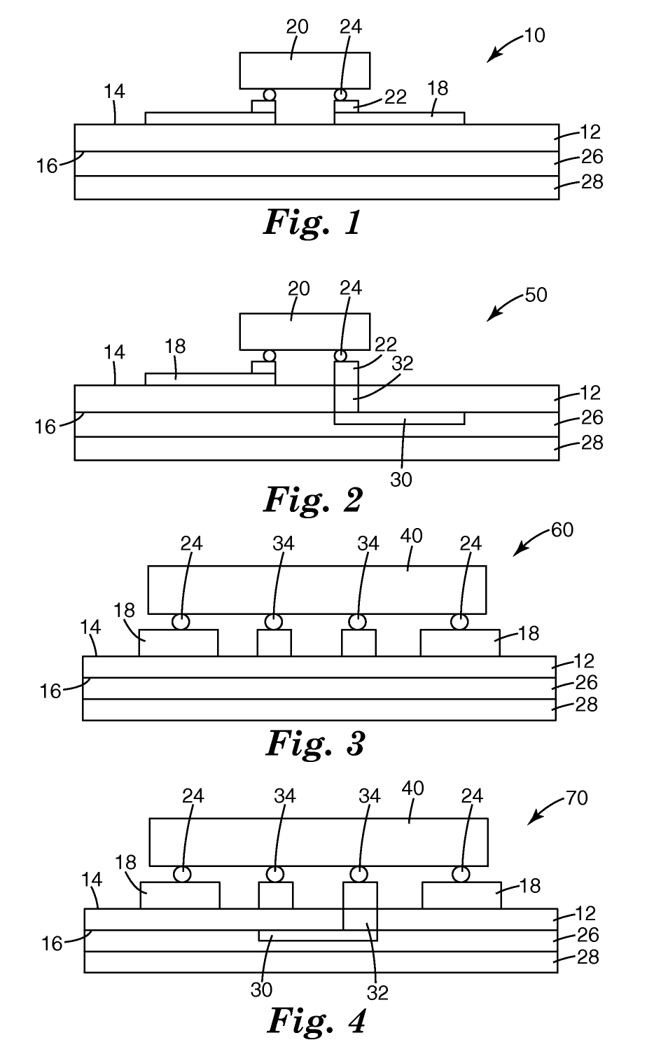

FIGS. 1-4 illustrate embodiments of a tamper-indicating radio frequency identification (“RFID”) tags of the present invention. Tamper-indicating RFID tags of the present invention are useful with electronic vehicle registration systems, which are described above. However the tamper-indicating RFID tags of the present invention are also useful with other RFID systems, as described below. The tamper-indicating RFID tags of the present invention assist a user in determining if the RFID tag has been tampered with or if someone has attempted to tamper with the tag. When using the term “tamper indicating” throughout this application, including the claims, it means to indicate that the attachment of the RFID tag to a surface has been interfered with, tinkered with, altered, modified, compromised or adjusted after the RFID tag has been attached to the surface. One example of how the attachment between the RFID tag and the surface may be interfered with or how the RFID tag may be detached from the surface is to bend, fold or stretch the substrate 12 away from the surface to which it is attached. Tampering could mean that the tag has been previously removed or attempted to be removed from the object to which it was issued or assigned, or that the tag has not been properly attached to the object to which is was issued or assigned.

In the example of a typical Electronic Vehicle Registration system, vehicle identification tags are issued to vehicle owners after the owners have registered their vehicles with such entities. The vehicle owner will apply the vehicle identification tag somewhere on the vehicle, such as on a window or license plate of the vehicle. However, it has been known that such vehicle identification tags have been stolen from the owner's vehicles and then reapplied to other vehicles, like a stolen vehicle, for instance, making the tag no longer a valid tag because it is attached to a vehicle that is different from the one that it was issued or assigned to. By the term “valid,” it is meant that the vehicle identification tag is properly issued by local, state, or federal government entities and that such tag is subsequently affiliated or otherwise attached to the vehicle to which it was issued. The tamper-indicating RFID tag of the present invention is directed at providing a user, typically a law enforcement agent, a way to verify that the vehicle identification tag is indeed a valid vehicle identification tag and that it is attached to the vehicle to which it was issued, that is, the tag has not been tampered with or tinkered with, altered, modified, adjusted or otherwise interfered with after it has been attached to the object to which it has been issued or assigned. To accomplish this, the tamper-indicating RFID tags of the present invention include materials that are useful for indicating tampering, specifically, piezoelectric materials. The piezoelectric materials generate a voltage when tampering or an attempt to tamper with the RFID tags of the present invention occurs, which results in the tag indicating tampering in a manner explained in more detail below.

Piezoelectric materials are well known. Simply stated, piezoelectric materials produce a voltage in response to an applied force or applied mechanical stress. Piezoelectric materials have been previously used in electromechanical devices, such as the following examples. In the case of a microphone transducer, sound of a particular frequency results in a strain in the material, which in turn induces an electric field. Similarly in speakers, a voltage input into the piezoelectric material can be converted into a mechanical strain, such as in a speaker transducer. In radios, piezoelectric devices can be used in tuners, where the correct strain in the crystal will amplify only the desired frequency. Piezoelectric materials are also employed in fine watch circuits, such as ones with “quartz movements. Some examples of known piezoelectric materials include quartz, barium titanate, lead niobate, and lead zirconate titanate.

Piezoelectric polymer materials are also well known. Examples of piezoelectric polymer materials and methods of making piezoelectric polymer materials are disclosed in U.S. Pat. Nos. 4,079,437, 4,089,034, 4,520,413, 4,606,871, and 4,615,848. Polyvinylidene fluoride (PVF₂) is an example of a suitable piezoelectric polymer material for use with the present invention. Examples of suitable polyvinylidene fluoride (PVF₂) films are commercially available from West Lake Plastics Company based in Los Angeles, Calif.

FIG. 1 illustrates one embodiment of the tamper-indicating RFID tag 10 of the present invention. The RFID tag 10 includes a substrate 12 having a first major surface 14 and a second major surface 16 opposite the first major surface 14. The substrate 12 could have enough flexibility to conform to a variety of surfaces and bend easily around objects. For example, in one embodiment, the substrate 12 is preferably in the range of 25-100 microns in thickness, and is made of a flexible material. Preferably, the substrate 12 includes piezoelectric materials. More preferably, the substrate 12 includes polymer piezoelectric materials, such as those describe above.

An RFID element is attached to one of the major surfaces of the substrate 12. The RFID element typically includes two major components: an integrated circuit 20 and an antenna 18. One example of a suitable RFID element is commercially available from TransCore LP located in Harrisburg, Pa. under the “eGo” brand. Some RFID tags include batteries to improve performance. These are commonly referred to as “active” tags. Passive tags do not include a battery. This invention is compatible with either type of tag. In the remainder of the description, passive tags will be assumed, unless otherwise stated.

The integrated circuit 20 provides the primary identification function. It includes software and circuitry to permanently store the tag identification and other desirable information, interpret and process commands received from the interrogation hardware, respond to requests for information by the interrogator, and assist the hardware in resolving conflicts resulting from multiple tags responding to interrogation simultaneously. Optionally, the integrated circuit 20 may provide for updating the information stored in its memory (read/write), as opposed to just reading the information out (read only). The integrated circuit 20 typically includes bonding pads 24 for attachment to the antenna 18. Integrated circuits suitable for use in RFID tags 10 include those available from Texas Instruments (in their line of products under the trade names TIRIS or TAG-IT), Philips (in their line of products under the trade names I-CODE, MIFARE and HITAG), among others.

The antenna 18 geometry and properties depend on the desired operating frequency of the RFID tag 10. For example, 915 MHz or 2.45 GHz RFID tags 10 might typically include a dipole antenna, such as a linear dipole antenna or a folded dipole antenna. A 13.56 MHz (or similar) RFID tag 10 would typically use a spiral or coil antenna. However, other antenna designs are known to those skilled in the art. Regardless, the antenna 10 intercepts the radio frequency energy radiated by an interrogation source, such as an RFID reader or interrogator. This signal energy carries both power and commands to the RFID tag 10. The antenna enables the RF-responsive element to absorb energy sufficient to power the integrated circuit 20 and thereby provide a response. Thus, the characteristics of the antenna should be matched to the system in which it is incorporated. Typically, the antenna 18 includes bonding pads 22, which assist in electrical connection between the antenna 18 and integrated circuit 20.

The adhesive and electrical connections between the integrated circuit 20 to the bonding pads 22 on the antenna 18 may be accomplished by anisotropic conductive adhesive, anisotropic conductive paste, anisotropic conductive film, or nonconductive paste or film. Conductive pastes and films comprise an adhesive matrix containing metallic or metal-coated particles to assist the electrical connection between the bonding pads 24 on the integrated circuit 20 to the bonding pads 22 on the antenna 18. The adhesive matrix may be a thermoplastic or thermoset adhesive. When nonconductive paste or film are used, the electrical connection between the bonding pads 24 on the integrated circuit 20 and the bonding pads 22 on the antenna 18 may be made by direct physical contact between them, by a suitable solder that is compatible with both the bump and pad metallurgy, or by wire bonding between the bonding pads 24 and the bonding pads 22. However, the adhesive and electrical connections between the integrated circuit 20 to the bonding pads 22 on the antenna 18 may be accomplished by other methods, as are well known to those skilled in the art.

As mentioned above, a user may use an RFID reader or interrogator to read information from or to write information to the RFID tag 10. RFID readers are well known in the art. For example, commercially available RFID readers are available from 3M Company based in St. Paul, Minn., as the 3M™ Digital Library Assistant as model numbers 702, 703, 802, and 803. Another example of a commercially available RFID reader is a model IP3 portable RFID (UHF) Reader attached to an Intermec™ 700 Series Mobile computer available from Intermec Technologies Corporation, Everett, Wash.

Information may be stored on the integrated circuit 20 of the RFID tag 10. The information may be the unique serial number that is stored on the RFID tag 10 when the RFID tag 10 is first manufactured. Alternatively, the information may be information that is written to the RFID tag 10 by an RFID interrogator. The information stored on the integrated circuit 20 may contain alphanumeric information, that is, consisting of or using letters, numbers, punctuation marks, mathematical, or other conventional symbols, or any combination thereof.

Tamper-indicating RFID tag 10 preferably includes an adhesive layer 26 on the second side 16 of the substrate 12. Suitable adhesives for use as adhesives 26 may be selected based on their adhesion strength to a surface of an object, for example, a glass window in a vehicle, as well as portions of tag 10. Adhesion strength of an adhesive to a given object may be varied depending on the components used to formulate an adhesive, as known to those skilled in the art. Adhesives useful in the present invention have been described in U.S. Pat. No. 5,725,935. Other examples of suitable adhesives are commercially available from 3M Company based in St. Paul, Minn., under Product Numbers 9457 and 9469. However, any number of adhesives known in the art may be used with the tamper-indicating RFID tag 10.

In yet another embodiment, the adhesive could be stripe-coated or coated in any pattern across the substrate 12, to have portions of the substrate with adhesive and to leave portions of the substrate without adhesive. The stripe-coated adhesive or patterned adhesive may include any number of types of adhesives having similar or different adhesive strengths and cohesive strengths.

Although FIG. 1 illustrates the tamper-indicating RFID tag 10 as including an adhesive 26 for attachment to an object, the tag 10 may be attached to a surface in any manner known in the art. For example, the tag 10 may be incorporated into a vehicle component, such as embedded in the windshield glass or the traditional license plate.

The RFID tag 10 may also optionally include a liner 28 on the layer of adhesive 26 for covering the layer of adhesive 26 until a user is ready to adhere the tag 10 to a surface. Suitable liner materials include polyethylene and silicon coated papers.

The tamper-indicating RFID tag 10 may include printed indicia (not shown) on the substrate 12 or may optionally include a cover layer (not shown) attached to the RFID tag 10 that may include printed indicia for example, a company logo, an advertisement, or information about the object to which the tag 10 is attached. The printed information or indicia may specifically include a bar code or other symbolic representation to allow a visual or optical confirmation of the information pertaining to the RFID tag 10. The cover layer may be directly attached to the substrate 12 for example, by lamination. Alternatively, the cover layer may be attached to the substrate 12 by another layer of adhesive. The adhesive can be the same as or different than the layer of adhesive 26. The cover layer and layer of adhesive are useful for attaching the RFID tags to an object. The cover layer may extend beyond the substrate 12 for example, it might be a tape that is used to affix the RFID tag to an object. Suitable materials for the cover layer include polyester films or papers. Alternatively, for example, the cover layer and layer of adhesive may be any commercially available tape or film sold by 3M Company, based in St. Paul, Minn.

FIG. 2 illustrates another embodiment of a tamper-indicating RFID tag of the present invention. Tamper-indicating RFID tag 50 is essentially the same design as RFID tag 10 illustrated in FIG. 1, except that a portion of the antenna 18 is on the first major surface 14 of substrate 12 and another portion of the antenna 30 is on the second major surface 16 of substrate 12, and that RFID tag 50 includes a through-hole via 32 for connecting antenna 18 and antenna 30. Antenna 18 and antenna 30 may be two discrete antennas, and could be referred to by the terms first antenna 18 and second antenna 30. Or, antenna 18 and antenna 30 may be considered separate portions of one antenna. The antenna 18 and antenna 30 are electrically connected by drilling and plating the through-hole via 32.

The piezoelectric material in substrate 12 of RFID tag 10, 50 responds to stress by producing an internal non-uniform charge distribution. Stress is created by a user attempting to tamper or tampering with the RFID tag 10, 50. The non-uniform charge distribution created can be detected as a voltage difference between physically separated regions of the material, such as the major surfaces 14, 16. The antenna 18, in the case of RFID tag 10, or the antenna 18, 30, in the case of RFID tag 50, serve as electrodes for sensing this generated voltage. In one embodiment of the present invention, this voltage, in effect, inhibits or destroys the functionality of the integrated circuit 20, preferably rendering it permanently inactive. This phenomenon could result from the stress caused by any attempt to remove the RFID tag 10, 50, even if tampering were not visually obvious to a user. Therefore, in one preferred embodiment of the RFID tag 10, before any tampering or attempt to tamper occurs, RFID tag 10, 50 responds appropriately to a signal sent by a RFID interrogator. This signal may be sent before the RFID tag 10 is adhered to the surface of an object or after the RFID tag 10 has been properly adhered to the surface. After the tamper-indicating RFID tag has been tampered with or attempts have been made to tamper with the RFID tag, the integrated circuit does not respond to the signal sent by the interrogator. The RFID tag may be remotely tested by the interrogator. If the integrated circuit of an individual RFID tag 10, 50 that is adhered to a surface of an object responds appropriately to the RFID interrogator, and at some time later, the antenna of the same RFID tag 10, 50 does not respond appropriately to the RFID interrogator, then this is an indication that the RFID tag 10, 50 has been tampered with.

Some commercially available integrated circuits 20 have static discharge protection built into the integrated circuit to prevent inadvertent chip destruction during processing and handling. This protection might interfere with the tamper-indicating features described above. Therefore, it is preferable that integrated circuits 20 in RFID tags 10, 50 that comply with the above described embodiment be designed with input circuitry capable of responding to the tamper indicating voltage by disabling chip functionality.

FIGS. 3 and 4 illustrate more alternative embodiments of the tamper-indicating RFID tag 60, 70 of the present invention. Tamper-indicating RFID tag 60 illustrated in FIG. 3 is essentially the same design as RFID tag 10 illustrated in FIG. 1, except that the RFID tag 60 includes integrated circuit 40 with tamper electrodes 34. Integrated circuit 40 preferably includes a memory for recording events. In this embodiment, the stress created in the substrate 12 by a user attempting to tamper or tampering with RFID tag 60 may be detected as a voltage generated in the piezoelectric material. This signal is collected by the tamper electrodes 34 in contact with substrate 12. This signal (voltage) causes a change or records an event in the memory on the integrated circuit 40. This phenomenon could result from the stress caused by any attempt to remove the RFID tag 60, even if tampering were not visually obvious to a user. Such a change to or recording of an event in the memory on the integrated circuit can be made responsive to tampering at levels much lower than those required for visual indications of tampering to be reliable. When the RFID tag 60 is interrogated, it will check the memory, and if an event is stored indicating the possibility of tampering, the chip modifies the response returned in a manner that will be recognized by the reader as signifying tampering. The RFID tag may be remotely tested by the interrogator. An example of a suitable integrated circuit 40 with tamper electrodes 34 is sold under the trade name IP-X4TTO, which is made by iPico based in Pretoria, South Africa. In this example, the integrated chip reverses the values in the CRC code, which is returned along with the tag unique ID number.

Yet another embodiment of the tamper-indicating RFID tag 70 of the present invention is illustrated FIG. 4. RFID tag 70 is essentially the same design as RFID tag 60 illustrated in FIG. 3, except that a portion of the antenna 18 is on the first major surface 14 of substrate 12 and another portion of the antenna 30 is on the second major surface 16 of substrate 12, and that RFID tag 70 includes a through-hole via 32 for connecting antenna 18 and antenna 30. Antenna 18 and antenna 30 may be two discrete antennas, and could be referred to by terms first antenna 18 and second antenna 30. Or, antenna 18 and antenna 30 may also be separate portions of one antenna. The antenna 18 and antenna 30 are electrically connected by drilling and plating the through-hole via 32. In this embodiment, the antenna 30 is electrically connected to one of the tamper electrodes 34 through via 32. The tamper electrodes 34 attached to antenna 18 and antenna 30 collect the voltage generated in the piezoelectric material in the substrate 12. This signal is collected by the tamper electrodes 34 in contact with substrate 12. This signal (voltage) causes a charge or records an event in the memory in the integrated circuit 40, as explained above.

In alternative embodiments of the present invention, RFID tags 10, 50, 60, 70 may also be convenient for detecting whether or not the tags have been properly attached to any object, thus inferring that if they were not properly attached, then the tags may not have been attached to the object by an authorized user and hence are not valid tags. For example, when the RFID tag undergoes stress, such as during the normal installation process of the tag to an object, it might trigger the tamper indicating function of the RFID tag explained above. Therefore, part of the preferred process for installation includes having the issuing authority or authorized installer of the RFID tag “activate” the tag by resetting the tamper-indicating memory location in the integrated circuit 40 either upon issuance or after attachment to the object to which the RFID tag 60, 70 is assigned, or could be accomplished by a specific installation procedure that is designed to minimize stress.

The RFID tags 10, 50, 60, 70 may be designed to communicate with an RFID reader at 13.56 MHz (so-called “high frequency” or “HF”), 915 MHz (so-called “ultra high frequency” or “UHF,” which generally also refers to frequencies including 868 MHz to 958 MHz) or any of a number of other frequencies, for example, frequencies allowed by regulatory agencies such as the Federal Communications Commission in the United States of America and similar agencies in other countries.

Antennas 18, 30 for the tamper-indicating RFD tags of the present invention may have general shapes that include circles, ovals, squares, rectangles, trapezoids, pentagons, hexagons, octagons, or any other regular or irregular shape, such as those well known to those skilled in the art.

Antennas 18, 30 for the tamper-indicating RFD tags of the present invention may optionally include various other design elements as are known to those skilled in the art, for example, tuning elements and impedance matching elements. These design elements may, for example, include tuning stubs, capacitors, variable feed points, ground planes, and additional coils.

Materials chosen for tamper-indicating RFID tags of the present invention may be selected from a range of materials, with the choice being dependent on manufacturing cost, manufacturing yield, tag performance in its intended use, environmental factors, and similar considerations.

Antennas 18, 30 and other conductive circuit elements may be patterned thick or thin films of copper, aluminum, silver, gold, other metals, or carbon. The antennas may also be printed in conductive inks comprising dispersions of silver, gold, or other metals, or particles coated with silver, gold or other metallic conductors, or nonmetallic conductors such as carbon or polyaniline. The antennas may be manufactured using commercially available flexible circuits that are produced using processes and designs of proven high yield.

The tamper-indicating RFID tags of the present invention may optionally be molded into or incorporated in various objects, containers, or housings, or the like.

The tamper-indicating RFID tag of the present invention may optionally include a layer of retroreflective material (not shown). Examples of a suitable retroreflective material are disclosed in U.S. Pat. No. 4,588,258, “Cube-Corner Retroreflective Articles having Wide Angularity in Multiple Viewing Planes, (Hoopman), and U.S. Pat. No. 5,450,235, “Flexible Cube-Corner Retroreflective Sheeting,” (Smith et al.), both of which are hereby incorporated by reference. Other examples of suitable retroreflective materials are taught in U.S. Pat. Nos. 3,190,178 and 2,407,680.

There are several uses of the tamper-indicating RFID tags of the present invention described herein. For example, the RFID tags may be applied to a first surface, then removed from the first surface, and tested for tampering, as described above. As another example, the RFID tags may be applied to a first surface, removed from the first surface, applied to a second surface, and tested for tampering, as described above. The RFID tags of the present invention are for asset identification and tracking and are particularly useful for providing additional protection against fraud or counterfeiting of those assets. For example, the tamper-indicating RFID tags of the present invention could be attached to government-related documents, such as passports, or attached to items related to the pharmaceutical industry, such as bottles of prescription drugs, or used in electronic vehicle registration systems, as described above or used with cargo containers, railroad box cards, and so forth.

The operation of the present invention will be further described with regard to the following detailed example. This example is offered to further illustrate the various specific and preferred embodiments and techniques. It should be understood, however, that many variations and modifications might be made while remaining within the scope of the present invention.

### EXAMPLE

A tamper-indicating RFID tag of the present invention illustrated in FIG. 3 or 4 could be constructed in the following manner. Either a passive (battery free) or active RFID chip could be used to construct a tamper indicating tag of the type illustrated in FIGS. 3 and 4. The RFID chip selected should include tamper electrodes 34 for connection to a substrate 12 for collecting the signal produced by the substrate. Both electrodes 34 could be attached to the same surface 14 of the substrate 12 as shown in FIG. 3. Alternatively, one of the electrodes 34 could be affixed to the opposite surface 16 of the substrate 12, by means of via 32, as shown in FIG. 4. The tamper electrodes 34 would also connect to a memory or logic function incorporated into the integrated circuit chip. This memory or logic function would be capable of receiving via tamper electrodes 34 a signal from substrate indicative of an attempt at tampering. This signal would cause a change to the internal state of the RFID chip. The state of the RFID chip subsequently could be examined, such as by interrogation with an RFID reader, to determine whether an attempt at tampering had occurred. According to the teachings of the present invention, the substrate 12 could be comprised of a piezoelectric material. In one preferred embodiment, the piezoelectric material 12 would be comprised of a flexible, polymeric piezoelectric material, such as poly(vinylidene fluoride).

In use, the tamper indicating tag could be affixed, for example, to the windshield of a vehicle through the use of the adhesive layer 26. Any attempt at tampering with the tag, such as by removal from the windshield of the vehicle, would result in a stress being applied to the piezoelectric substrate 12. This stress would, in turn, result in the generation of a voltage by the piezoelectric material. This signal (voltage) would be collected by the tamper electrodes 34 affixed to the piezoelectric substrate directly, or by attachment to antenna 18, 30. The signal at tamper electrodes 34 could in turn cause a change in the internal state of the RFID chip 40. One example of this change in state might be the reversal of the information stored in a memory cell. The voltage required to cause such a reversal varies with the design of the chip. Typical voltage values might be 1 to 5 volts. For example, one RFID chip known in the art, a component of RFID tag IP-4XTTO available from iPico, Inc., Pretoria, South Africa, requires a voltage of approximately 2.3 volts to change the state of a memory location. Someone attempting to remove a tag adhered to the windshield of a vehicle would be expected to subject the tag to a stress no less than between 1 and 10 Newtons. The piezoelectric substrate 12 could typically have a thickness between 25 and 100 microns. Using the dielectric constant and piezoelectric coupling coefficient corresponding to poly(vinylidene fluoride) and a reasonable size of substrate 12, generally corresponding to the length and width dimensions of the IP-4XTTO RFID tag, an attempt at tampering would be expected to generate a voltage at the tamper electrodes 34 of between 1 and 10 volts.

The present invention has now been described with reference to several embodiments thereof. The foregoing detailed description and examples have been given for clarity of understanding only. No unnecessary limitations are to be understood therefrom. All patents and patent applications cited herein are hereby incorporated by reference. It will be apparent to those skilled in the art that many changes can be made in the embodiments described without departing from the scope of the invention. Thus, the scope of the present invention should not be limited to the exact details and structures described herein, but rather by the structures described by the language of the claims, and the equivalents of those structures.

What is claimed is:

1. A tamper-indicating radio frequency identification tag, comprising:
a substrate including a first major surface and a second major surface opposite the first major surface, wherein the substrate comprises piezoelectric material;
a radio frequency identification antenna on the first major surface of the substrate; and
an integrated circuit electrically connected to the antenna;
wherein a voltage is generated in the piezoelectric material when the tag is tampered with.

2. The tamper-indicating radio frequency identification tag of claim 1, wherein the integrated circuit will not function as a result of the voltage generated in the piezoelectric material.

3. The tamper-indicating radio frequency identification tag of claim 2, wherein when the tag is interrogated by a radio frequency identification reader, the integrated circuit does not respond.

4. The tamper-indicating radio frequency identification tag of claim 1, wherein the integrated circuit comprises a memory for recording events, and wherein when tampering of the tag occurs, an event is recorded in the memory.

5. The tamper-indicating radio frequency identification tag of claim 4, wherein when the tag is interrogated by a radio frequency identification reader, the tag responds with information related to any event.

6. The tamper-indicating radio frequency identification tag of claim 1, wherein the tag may be remotely tested for tampering.

7. The tamper-indicating radio frequency identification tag of claim 1, wherein the tag indicates tampering even if there is no visible indication of tampering.

8. The tamper-indicating radio frequency identification tag of claim 1 further comprising tamper electrodes electrically attached to the integrated circuit.

9. The tamper-indicating radio frequency identification tag of claim 8, wherein the integrated circuit further comprises a memory for recording tampering events, and wherein when a voltage is generated in the piezoelectric material, a tampering event is recorded in the memory of the integrated circuit.

10. The tamper-indicating radio frequency identification tag of claim 1, wherein the substrate comprises piezoelectric polymer film.

11. An electronic vehicle identification tag comprising the tamper-indicating radio frequency identification tag of claim 1.

12. The tamper-indicating radio frequency identification tag of claim 1 in combination with an item to which the tag was assigned, wherein the item is a vehicle.

13. A tamper-indicating radio frequency identification tag, comprising:
a substrate including a first major surface and a second major surface opposite the first major surface, wherein the substrate comprises piezoelectric material; and
a radio frequency identification antenna on the first major surface of the substrate; and
an integrated circuit electrically connected to the first antenna, wherein the integrated circuit comprises a memory for recording events;
wherein when tampering of the tag occurs, a voltage is generated in the piezoelectric material and an event is recorded in the memory.

14. The tamper-indicating radio frequency identification tag of claim 13, wherein when the tag is interrogated by a radio frequency identification reader, the integrated circuit responds with information related to any event.

15. The tamper-indicating radio frequency identification tag of claim 13, wherein the tag may be remotely tested for tampering.

16. The tamper-indicating radio frequency identification tag of claim 13, wherein the tag indicates tampering even if there is no visible indication of tampering.

17. The tamper-indicating radio frequency identification tag of claim 13 further comprising tamper electrodes electrically attached to the integrated circuit.

18. The tamper-indicating radio frequency identification tag of claim 13, wherein the substrate comprises piezoelectric polymer film.

19. An electronic vehicle identification tag comprising the tamper-indicating radio frequency identification tag of claim 13.

20. The tamper-indicating radio frequency identification tag of claim 13 in combination with an item to which the tag was assigned, wherein the item is a vehicle.

21. A method of indicating tampering of a radio frequency identification tag, comprising the steps of:
providing a tamper-indicating radio frequency identification tag, comprising:
a substrate including a first major surface and a second major surface opposite the first major surface, wherein the substrate comprises piezoelectric material;
a radio frequency identification antenna on the first major surface of the substrate; and
an integrated circuit electrically connected to the antenna;
wherein a voltage is generated in the piezoelectric material when the tag is tampered with;
attaching the tamper-indicating radio frequency identification tag to an assigned item;
tampering the radio frequency identification tag by attempting to remove or removing the tag from the assigned item; and
receiving an indication that the radio frequency identification tag has been tampered with by detecting a change in the response of the integrated circuit due to the voltage generated in the piezoelectric material.

22. The method of claim 21, wherein the integrated circuit comprises a memory for recording events, and wherein the tampering step comprises recording a tampering event in the memory.

23. The method of claim 22 further comprising the steps of
interrogating the tag by a radio frequency identification reader; and
receiving from the integrated circuit information related to any tampering event.

24. The method of claim 21, wherein the tampering step comprises damaging the functionality of the integrated circuit.

25. The method of claim 24 further comprising the steps of:
interrogating the tag by a radio frequency identification reader; and
not receiving a response from the integrated circuit.
